(19) United States
(12) Patent Application Publication
(10) Pub. No.: US 2022/0162459 A1
(43) Pub. Date: May 26, 2022

(54) MOISTURE-SENSED SHRINKING INK

(71) Applicant: TAIWAN TEXTILE RESEARCH INSTITUTE, NEW TAIPEI CITY (TW)

(72) Inventors: Sun-Wen JUAN, NEW TAIPEI CITY (TW); Chia-Yi LIN, NEW TAIPEI CITY (TW); Chun-Hung LIN, NEW TAIPEI CITY (TW); Jung-Yu TSAI, NEW TAIPEI CITY (TW)

(21) Appl. No.: 17/308,223

(22) Filed: May 5, 2021

(30) Foreign Application Priority Data
Nov. 23, 2020 (TW) 109141018

(51) Int. Cl. C09D 11/102; C09D 175/08

(52) U.S. Cl. CPC C09D 11/102; C09D 175/08

(57) ABSTRACT

A moisture-sensed shrinking ink applied to a digital printing process for fabric has a viscosity between 2.5 cP and 10.0 cP and a surface tension between 22 dyne/cm and 32 dyne/cm, in which the moisture-sensed shrinking ink includes 15 parts by weight to 35 parts by weight of a moisture-sensed shrinking resin and 65 parts by weight to 85 parts by weight of water.

### RELATED APPLICATION

This application claims priority to Taiwan Application Serial Number 109141018, filed Nov. 23, 2020, which is herein incorporated by reference.

### BACKGROUND

### Field of Disclosure

The present disclosure relates to a moisture-sensed shrinking ink, and particularly relates to a moisture-sensed shrinking ink applied in a digital printing process for fabric.

### Description of Related Art

In recent years, people's awareness of family leisure and health has gradually increased, and hence the consumers' demand for functional fabrics has also increased. One of the functional fabrics popular among consumers is a moisture-sensed deforming fabric, which not only can quickly absorb sweat, but also has air permeability, so as to keep the human body dry. Therefore, how to perform the moisture-sensed shrinking process on fabric is one of the most important developments of post-treatment in recent years.

### SUMMARY

The present disclosure provides a moisture-sensed shrinking ink, which can be applied in the digital printing process for fabric, so as to be precisely sprayed on a base cloth, such that a moisture-sensed deforming fabric fabricated thereby can be provided with a good moisture-sensed shrinking property.

According to some embodiments of the present disclosure, the moisture-sensed shrinking ink applied to a digital printing process for fabric has a viscosity between 2.5 cP and 10.0 cP and a surface tension between 22 dyne/cm and 32 dyne/cm. The moisture-sensed shrinking ink includes 15 parts by weight to 35 parts by weight of a moisture-sensed shrinking resin and 65 parts by weight to 85 parts by weight of water.

In some embodiments of the present disclosure, the moisture-sensed shrinking resin is manufactured by the following reagents, including a polyol, a polyamine, a first cross-linking agent, and a second cross-linking agent. Each of the first cross-linking agent and the second cross-linking agent includes an isocyanate block.

In some embodiments of the present disclosure, an average molecular weight of the polyol is between 200 g/mole and 600 g/mole.

In some embodiments of the present disclosure, the polyol is an ether polyol comprising polyethylene glycol, polypropylene glycol, or poly(tetramethylene ether) glycol.

In some embodiments of the present disclosure, an average molecular weight of the polyamine is between 600 g/mole and 8000 g/mole.

In some embodiments of the present disclosure, the polyamine includes aliphatic amine, polyimide, polyamide, or polyetheramine.

In some embodiments of the present disclosure, the first cross-linking agent and the second cross-linking agent have a same molecular structure.

In some embodiments of the present disclosure, a particle diameter (D90) of the moisture-sensed shrinking ink is between 90 nm and 360 nm.

In some embodiments of the present disclosure, the moisture-sensed shrinking ink further includes 0.004 parts by weight to 0.060 parts by weight of a surfactant.

In some embodiments of the present disclosure, the moisture-sensed shrinking ink further includes 5 parts by weight to 10 parts by weight of a moisturizer.

In some embodiments of the present disclosure, the moisturizer is glycerol, diethylene glycol, propylene glycol methyl ether, or combinations thereof.

In some embodiments of the present disclosure, the moisture-sensed shrinking ink further includes 0.002 parts by weight to 0.020 parts by weight of a defoamer.

According to the aforementioned embodiments of the present disclosure, by adjusting each of the ingredients in the moisture-sensed shrinking ink, the moisture-sensed shrinking ink can be provided with a good moisture-sensed shrinking property, and the moisture-sensed shrinking ink can be sprayed on a base cloth through the digital printing process to form the moisture-sensed deforming fabric with a breathable perspiration function. On the other hand, by spraying the moisture-sensed shrinking ink onto the base cloth through the digital printing process, the fabric can be precisely provided with a partial or overall moisture-sensed shrinking property, so as to avoid the excessive use of chemical agents to further reduce waste and effectively reduce costs.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

In the present disclosure, the structure of a polymer or a functional group is sometimes represented by a skeleton formula. This representation can omit carbon atoms, hydrogen atoms, and carbon-hydrogen bonds. Certainly, if the atom or atom group is clearly drawn in the structural formula, the drawing shall prevail.

The present disclosure provides a moisture-sensed shrinking ink, which can be applied in the digital printing process for fabric, so as to be precisely sprayed on a base cloth, such that a moisture-sensed deforming fabric fabricated thereby can be provided with a good moisture-sensed shrinking property, and the excessive use of chemical agents can be avoided to further reduce waste and effectively reduce costs. The digital printing process is a discontinuous phase coating method, in which the nozzle of the inkjet device will not be in contact with the fabric to be processed. The digital printing process has advantages of precise positioning, high usage rate of chemical agents, reduction of waste discharge, low energy consumption of processing, effective cost reduction, rapid sampling for small batches, and so on. Fabric finishing plants, fabric coating plants, and fabric surface processing industries can utilize the moisture-sensed shrinking ink of the present disclosure to perform fabric inkjet coating, inkjet finishing, precision coating, surface modification, surface and interior differentiation treatments, and so on.

The moisture-sensed shrinking ink of the present disclosure mainly includes 15 parts by weight to 35 parts by weight of a moisture-sensed shrinking resin and 65 parts by weight to 85 parts by weight of water. A viscosity of the moisture-sensed shrinking ink is between 2.5 cP and 10.0 cP, such that the ink droplets can be sprayed with a suitable size, and the moisture-sensed shrinking ink can have suitable fluidity to facilitate the digital printing process. On the other hand, a surface tension of the moisture-sensed shrinking ink is between 22 dyne/cm and 32 dyne/cm, which facilitates the formation of the ink droplets at the nozzle and provides the moisture-sensed shrinking ink with good permeability.

In some embodiments, a particle diameter (D90) of the dispersant in the moisture-sensed shrinking ink may be between 90 nm and 360 nm, such that the problem of nozzle clogging during the digital printing process can be avoided, and the moisture-sensed shrinking ink can be provided with good stability. The particle diameter (D90) of the aforementioned dispersant will also affect the viscosity of the moisture-sensed shrinking ink. For example, a smaller dispersant particle diameter in moisture-sensed shrinking ink can provide the moisture-sensed shrinking ink with a lower viscosity. In some embodiments, the moisture-sensed shrinking ink may have a pH value between 6.0 and 8.5 at 25° C., so as to avoid corrosion of the nozzle of the printing device, and prevent the ink droplets from depositing at the nozzle resulting in nozzle clogging.

The moisture-sensed shrinking ink includes the moisture-sensed shrinking resin. In some embodiments, the moisture-sensed shrinking ink has a plurality of amino groups and hydroxyl groups, and can be firmly disposed on the base cloth, so as to improve the moisture-sensed shrinking property and washing fastness of the moisture-sensed deforming fabric fabricated thereby. In other words, since the moisture-sensed shrinking ink of the present disclosure includes the moisture-sensed shrinking resin, the moisture-sensed shrinking ink of the present disclosure can provide the moisture-sensed deforming fabric fabricated thereby with high shrinking ratio per unit area, and the moisture-sensed deforming fabric can well maintain its moisture-sensed shrinking property after multiple times of washing.

In some embodiments, the moisture-sensed shrinking resin may be manufactured by the following reagents, which includes a polyol, a polyamine, a first cross-linking agent, and a second cross-linking agent. In some embodiments, an additive amount of the polyol may be between 0.5 parts by weight to 1.5 parts by weight, an additive amount of the polyamine may be between 40 parts by weight to 50 parts by weight, an additive amount of the first cross-linking agent may be between 2.2 parts by weight to 2.6 parts by weight, and an additive amount of the second cross-linking agent may be between 0.4 parts by weight to 0.8 parts by weight.

In some embodiments, the polyol can provide the moisture-sensed shrinking resin with a good moisture-sensed shrinking property, such that the moisture-sensed shrinking ink can be provided with a good moisture-sensed shrinking property. As such, the moisture-sensed deforming fabric manufactured by the moisture-sensed shrinking ink can be provided with high shrinking ratio per unit area. In some embodiments, the polyol may be, for example, an ether polyol including polyethylene glycol (PEG), polypropylene glycol (PPG), or poly(tetramethylene ether) glycol (PTMEG). In some embodiments, an average molecular weight of the polyol may be between 200 g/mole and 600 g/mole. Specifically, if the average molecular weight of the polyol is less than 200 g/mole, the moisture-sensed shrinking resin formed may not be firmly disposed on the base cloth, and hence the moisture-sensed deforming fabric has poor moisture-sensed shrinking property and washing fastness; and if the average molecular weight of the polyol is greater than 600 g/mole, the viscosity of the moisture-sensed shrinking ink may be too high, causing the ink droplets to gather, which results in the problem of nozzle dogging.

In some embodiments, the polyamine can provide the moisture-sensed shrinking resin with a good moisture-sensed shrinking property, such that the moisture-sensed shrinking ink can be provided with a good moisture-sensed shrinking property. As such, the moisture-sensed deforming fabric manufactured by the moisture-sensed shrinking ink can be provided with high shrinking ratio per unit area. In some embodiments, the polyamine may include polyimide, polyamide, or polyetheramine. In some other embodiments, the polyamine may include aliphatic amine, so as to better provide the moisture-sensed shrinking resin with a good moisture-sensed shrinking property.

Specifically, the aliphatic amine may be, for example, hexylenediamine, diethylhexamethylenediamine, trimethylhexamethylenediamine, heptanediamine, trimethylethylenediamine, tetraethylethylenediamine, tetramethylethylenediamine, nonanediamine, laurylamine dipropylenediamine, diethylenetriamine, triethylenetetramine, or polyethyleneimine. In some embodiments, an average molecular weight of the polyamine may be between 600 g/mole and 8000 g/mole, and preferably between 800 g/mole and 5500 g/mole.

In some embodiments, the first cross-linking agent may include isocyanate trimer. Specifically, the first cross-linking agent may include a structural unit represented by formula (1),

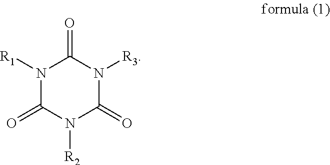

In some embodiments, the first cross-linking agent may include aliphatic isocyanate (e.g., HDI, TMDI or XDI) trimer, alicyclic isocyanate (e.g., IPDI, HMDI or HTDI) trimer, aromatic isocyanate (e.g., TDI or MDI) trimer, or combinations thereof. The first cross-linking agent may include an isocyanate block. For example, at least two terminals of the isocyanate trimer may have the isocyanate blocks. Specifically, in the first cross-linking agent represented by formula (1), any two or more of R1, R2, and R3 include the isocyanate blocks.

In some embodiments, the second cross-linking agent and the first cross-linking agent may have the same molecular structure. In some embodiments, a ratio of the additive amount of the second cross-linking agent to the additive amount of the first cross-linking agent may be, for example, between 1:5 and 1:3. In some embodiments, a ratio of a total number of the isocyanate block to a total number of the hydroxyl group may be between 1.0 and 2.5.

In some embodiments, the moisture-sensed shrinking ink may further include 5 parts by weight to 10 parts by weight of a moisturizer. Within such a content range, the moisture-sensed shrinking ink can be prevented from deposition or nozzle clogging due to agglomeration during the printing process. Specifically, if the content of the moisturizer is less than 5.0 parts by weight, the agglomeration of the moisture-sensed shrinking ink may not be effectively prevented; and if the content of the moisturizer is greater than 10 parts by weight, the drying rate of the moisture-sensed shrinking ink on the fabric is likely to be too slow, which reduces the overall production rate of the digital printing process. In some embodiments, the moisturizer may be, for example, glycerol, diethylene glycol, propylene glycol methyl ether, or combinations thereof.

In some embodiments, the moisture-sensed shrinking ink may further include 0.004 parts by weight to 0.060 parts by weight of a surfactant. Within such a content range, the surfactant can maintain the size of the particles (such as the moisture-sensed shrinking resin, the moisturizer, etc.) in the moisture-sensed shrinking ink. Specifically, if the content of the surfactant is less than 0.004 parts by weight, the dispersant in the moisture-sensed shrinking ink cannot be completely dispersed, and precipitates or agglomerates may be generated; and if the content of the surfactant is greater than 0.060 parts by weight, the aggregation between the dispersed substances will be lost due to the repulsive force generated by the excessive surfactant. In some embodiments, the surfactant may be, for example, polydimethylsiloxane, polyether modified siloxane, polyether modified polydimethylsiloxane, or combinations thereof.

In some embodiments, the moisture-sensed shrinking ink may further include 0.002 parts by weight to 0.020 parts by weight of a defoamer. Within such a content range, it can be ensured that no foam is in the moisture-sensed shrinking ink. Specifically, if the content of the defoamer is less than 0.002 parts by weight, foam may be easily generated due to the alkaline ingredients in the moisture-sensed shrinking ink, thereby affecting the stability of the moisture-sensed shrinking ink and the smoothness during printing; and if the content of the agent is greater than 0.020 parts by weight, the viscosity and the surface tension of the moisture-sensed shrinking ink may be too low, thereby affecting the overall properties of the ink. In some embodiments, the defoamer may be, for example, polyether modified polydimethysiloxane, foam breaking polysiloxane, a mixture of foam breaking polysiloxane and hydrophobic particles dissolved in polyethylene glycol, or combinations thereof.

According to the aforementioned embodiments of the present disclosure, by adjusting each of the ingredients in the moisture-sensed shrinking ink, the moisture-sensed shrinking ink can be provided with a good moisture-sensed shrinking property, and the moisture-sensed shrinking ink can be sprayed on the base cloth through the digital printing process to form the moisture-sensed deforming fabric with a breathable perspiration function. On the other hand, by spraying the moisture-sensed shrinking ink on the base cloth through the digital printing process, the fabric can be precisely provided with a partial or overall moisture-sensed shrinking property, so as to avoid the excessive use of chemical agents to further reduce waste and effectively reduce costs.

In the following descriptions, various tests and evaluations will be performed on the moisture-sensed shrinking ink and the moisture-sensed deforming fabric fabricated by the moisture-sensed shrinking ink of the present disclosure.

### Experiment 1: Evaluation on the Basic Ingredients of the Moisture-Sensed Shrinking Ink

In this experiment, the viscosity, surface tension, and particle diameter of the moisture-sensed shrinking ink of each embodiment are measured. The ingredients and their contents in the moisture-sensed shrinking ink of each embodiment and the measurement results are shown in Table 1.

TABLE 1

| | | | | | | | surface | particle |
|---|---|---|---|---|---|---|---|---|
| | | moisture-sensed | | | | viscosity | tension | diameter |
| | water | shrinking resin | moisturizer | surfactant | defoamer | (cP) | (dyne/cm) | (nm) |
| embodiment | 80 | 20 | — | 0.004 | — | 3.5 | 28.0 | 187 |
| 1 | | | | (D) | | | | |
| embodiment | 80 | 20 | — | 0.008 | 0.002 | 3.5 | 27.3 | 187 |
| 2 | | | | (D) | (G) | | | |
| embodiment | 80 | 20 | 5 | 0.004 | — | 5.0 | 28.2 | 187 |
| 3 | | | (A) | (D) | | | | |
| embodiment | 80 | 20 | 5 | 0.008 | 0.002 | 5.0 | 28.7 | 188 |
| 4 | | | (A) | (D) | (G) | | | |
| embodiment | 80 | 20 | 10 | 0.004 | — | 6.4 | 31.3 | 335 |
| 5 | | | (A) | (D) | | | | |
| embodiment | 80 | 20 | 10 | 0.008 | 0.002 | 6.4 | 30.3 | 327 |
| 6 | | | (A) | (D) | (G) | | | |
| embodiment | 80 | 20 | 5 | 0.002 | — | 4.8 | 28.4 | 173 |
| 7 | | | (B) | (D) | | | | |
| embodiment | 80 | 20 | 5 | 0.002 | 0.002 | 4.8 | 28.1 | 173 |
| 8 | | | (B) | (D) | (G) | | | |
| embodiment | 80 | 20 | 10 | 0.002 | — | 5.6 | 31.5 | 334 |
| 9 | | | (B) | (D) | | | | |
| embodiment | 80 | 20 | 10 | 0.002 | 0.002 | 5.6 | 28.3 | 334 |
| 10 | | | (B) | (D) | (G) | | | |
| embodiment | 80 | 20 | 5 | 0.002 | — | 4.5 | 27.5 | 189 |
| 11 | | | (C) | (D) | | | | |
| embodiment | 80 | 20 | 5 | 0.002 | 0.002 | 4.5 | 27.8 | 189 |
| 12 | | | (C) | (D) | (G) | | | |
| embodiment | 80 | 20 | 10 | 0.002 | — | 5.3 | 29.3 | 352 |
| 13 | | | (C) | (D) | | | | |
| embodiment | 80 | 20 | 10 | 0.002 | 0.002 | 5.3 | 25.5 | 352 |
| 14 | | | (C) | (D) | (G) | | | |
| embodiment | 80 | 20 | — | 0.060 | — | 2.6 | 22.5 | 124 |
| 15 | | | | (E) | | | | |
| embodiment | 80 | 20 | — | 0.060 | 0.020 | 2.8 | 24.2 | 106 |
| 16 | | | | (E) | (H) | | | |
| embodiment | 80 | 20 | — | 0.040 | — | 2.7 | 22.4 | 118 |
| 17 | | | | (F) | | | | |
| embodiment | 80 | 20 | — | 0.040 | 0.015 | 2.8 | 25.4 | 95 |
| 18 | | | | (F) | (I) | | | |
| embodiment | 70 | 30 | — | 0.060 | — | 8.5 | 22.5 | 153 |
| 19 | | | | (E) | | | | |
| embodiment | 70 | 30 | — | 0.060 | 0.020 | 8.5 | 23.6 | 145 |
| 20 | | | | (E) | (H) | | | |

Note 1:
The unit unannotated is part by weight.
Note 2:
(A) represents glycerol;
(B) represents diethylene glycol;
(C) represents propylene glycol methyl ether.
Note 3:
(D) represents polyether modified siloxane;
(E) represents polyether modified polydimethylsiloxane;
(F) represents polydimethylsiloxane.
Note 4:
(G) represents polyether modified polydimethylsiloxane;
(H) represents foam breaking polysiloxane;
(I) represents a mixture of foam breaking polysiloxane and hydrophobic particles dissolved in polyethylene glycol.

It can be seen from Table 1 that the moisture-sensed shrinking ink of each embodiment has a viscosity between 2.5 cP and 10.0 cP, a surface tension between 22 dyne/cm to 32 dyne/cm, and a particle diameter between 90 nm and 360 nm. Therefore, the moisture-sensed shrinking ink of each embodiment has suitable fluidity, and can facilitate the formation of ink droplets and provide the ink droplets with good permeability. In addition, the problems of ink deposition and nozzle dogging to the moisture-sensed shrinking ink are unlikely to occur.

### Experiment 2: Evaluation on Storage Stability of the Moisture-Sensed Shrinking Ink

In this experiment, high-temperature, room-temperature, and low-temperature storage stability tests are performed on the moisture-sensed shrinking ink of each embodiment. Specifically, the high-temperature storage stability test is to place the moisture-sensed shrinking ink in an oven at a temperature of 60° C. for 15 days and wait until it returns to room temperature for testing; the room-temperature storage stability test is to place the moisture-sensed shrinking ink in a room-temperature environment for 15 days for testing; the low-temperature storage stability test is to place the moisture-sensed shrinking ink in a fridge at a temperature of 7° C. for 15 days and wait until it returns to room temperature for testing. The test includes visually observing whether the delamination phenomenon occurs or any precipitate is generated in the moisture-sensed shrinking ink, and measuring the viscosity of the moisture-sensed shrinking ink which is compared to the viscosity of the moisture-sensed shrinking ink before the test. The test results are shown in Table 2.

TABLE 2

| | high- | room- | low- |
|---|---|---|---|
| | temperature | temperature | temperature |
| | storage | storage | storage |
| | stability test | stability test | stability test |
| embodiment 1 | 15 days | 15 days | 15 days |
| embodiment 2 | 15 days | 15 days | 15 days |
| embodiments 3-14 | 7 days | 15 days | 15 days |
| embodiments 15-18 | 15 days | 15 days | 15 days |
| embodiments 19-20 | 15 days | 15 days | 15 days |

Note:
The number of days shown in Table 2 means that the delamination phenomenon does not occur or the precipitate is not generated in the moisture-sensed shrinking ink during this number of days, and that the viscosity change in the moisture-sensed shrinking ink is rather small.

It can be seen from Table 2 that no matter in the high-temperature, room-temperature, or low-temperature environment, the moisture-sensed shrinking ink of each embodiment can be stored for at least 7 days without delamination phenomenon occurring and precipitate being generated, and the viscosity change in the moisture-sensed shrinking ink is rather small. In other words, the moisture-sensed shrinking ink of each embodiment can be stored for at least 7 days without deterioration in high-temperature, room-temperature, and low-temperature environments, showing good storage stability. It should be understood that when the time that the moisture-sensed shrinking ink can be stably stored in the high-temperature environment is converted into the time that the moisture-sensed shrinking ink can be stably stored in the room-temperature environment, the moisture-sensed shrinking ink of each embodiment can be stably stored at room temperature for about 6 months to 2 years.

Experiment 3: Evaluation on Stability of the Moisture-Sensed Shrinking INK after being Sprayed on the Base Cloth

In this experiment, the moisture-sensed shrinking ink of each embodiment is sprayed on a polyester knitted fabric or a nylon knitted fabric by the digital printing process to form a moisture-sensed deforming fabric with an inkjet pattern, the moisture-sensed deforming fabric is then placed in a room-temperature environment for 7 days, and the clarity of the inkjet pattern is observed with naked eyes. The results show that inkjet pattern formed by the moisture-sensed shrinking ink of each embodiment do not obviously spread out, having good pattern stability.

### Experiment 4: Evaluation on the Moisture-Sensed Shrinking Property of the Moisture-Sensed Deforming Fabric

In this experiment, the moisture-sensed shrinking ink of each embodiment is sprayed on a polyester knitted fabric to form a moisture-sensed shrinking, and each moisture-sensed deforming fabric is subjected to a shrinking ratio per unit area test. It should be noted that the shrinking ratio per unit area of each moisture-sensed deforming fabric is the test result of a moisture-sensed deforming fabric with an area of 10 cm×10 cm. In addition, each moisture-sensed deforming fabric is subjected to 50 times of washing, and the test is conducted again after the 20^{th} and 50^{th} times of washing. The test results are shown in Table 3.

TABLE 3

| | number of | shrinking ratio per unit |
|---|---|---|
| | washing (times) | area of fabric (%) |
| embodiments 1-2 | 0 | 16.4 |
| | 20 | 11.7 |
| | 50 | 10.7 |
| embodiments 3-4 | 0 | 13.6 |
| | 20 | 9.7 |
| | 50 | 8.9 |
| embodiments 5-6 | 0 | 12.7 |
| | 20 | 9.1 |
| | 50 | 8.3 |
| embodiments 7-8 | 0 | 14.5 |
| | 20 | 10.3 |
| | 50 | 9.5 |
| embodiments 9-10 | 0 | 12.8 |
| | 20 | 9.1 |
| | 50 | 8.4 |
| embodiments 11-12 | 0 | 12.6 |
| | 20 | 9.0 |
| | 50 | 8.2 |
| embodiments 13-14 | 0 | 11.7 |
| | 20 | 8.3 |
| | 50 | 7.6 |
| embodiments 15-18 | 0 | 14.4 |
| | 20 | 10.3 |
| | 50 | 9.4 |
| embodiments 19-20 | 0 | 15.4 |
| | 20 | 12.8 |
| | 50 | 10.7 |

As shown in Table 3, before each moisture-sensed deforming fabric is being washed, the shrinking ratio per unit area of each moisture-sensed deforming fabric is between 11% and 17%, indicating that each moisture-sensed deforming fabric has a good moisture-sensed shrinking property. On the other hand, the shrinking ratio per unit area of each moisture-sensed deforming fabric after 50 times of washing is still larger than 9%, which successfully overcomes the problem of poor washing fastness caused by the use of conventional processing additives.

Through the verification of the above experiments, the moisture-sensed shrinking ink of the present disclosure can have suitable fluidity and good permeability, and can be substantially stable under a high-temperature, room-temperature, or low-temperature environment. In addition, the inkjet pattern formed by the moisture-sensed shrinking ink of the present disclosure can be provided with good pattern stability. On the other hand, the moisture-sensed shrinking ink of the present disclosure can provide a good moisture-sensed shrinking property, and can be precisely sprayed on the base cloth through the digital printing process to form the moisture-sensed deforming fabric with a breathable perspiration function. In addition, the moisture-sensed shrinking ink of the present disclosure can be firmly disposed on the base cloth, which is beneficial to improve the washing fastness of the moisture-sensed deforming fabric.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. A moisture-sensed shrinking ink, applied to a digital printing process for fabric, and having a viscosity between 2.5 cP and 10.0 cP and a surface tension between 22 dyne/cm and 32 dyne/cm, wherein the moisture-sensed shrinking ink comprises 15 parts by weight to 35 parts by weight of a moisture-sensed shrinking resin and 65 parts by weight to 85 parts by weight of water.

2. The moisture-sensed shrinking ink of claim 1, wherein the moisture-sensed shrinking resin is manufactured by the following reagents, comprising:
a polyol;
a polyamine;
a first cross-linking agent, comprising an isocyanate block; and
a second cross-linking agent, comprising an isocyanate block.

3. The moisture-sensed shrinking ink of claim 2, wherein an average molecular weight of the polyol is between 200 g/mole and 600 g/mole.

4. The moisture-sensed shrinking ink of claim 2, wherein the polyol is an ether polyol comprising polyethylene glycol, polypropylene glycol, or poly(tetramethylene ether) glycol.

5. The moisture-sensed shrinking ink of claim 2, wherein an average molecular weight of the polyamine is between 600 g/mole and 8000 g/mole.

6. The moisture-sensed shrinking ink of claim 2, wherein the polyamine comprises aliphatic amine, polyimide, polyamide, or polyetheramine.

7. The moisture-sensed shrinking ink of claim 2, wherein the first cross-linking agent and the second cross-linking agent have a same molecular structure.

8. The moisture-sensed shrinking ink of claim 1, wherein a particle diameter (D90) of the moisture-sensed shrinking ink is between 90 nm and 360 nm.

9. The moisture-sensed shrinking ink of claim 1, further comprising 0.004 parts by weight to 0.060 parts by weight of a surfactant.

10. The moisture-sensed shrinking ink of claim 1, further comprising 5 parts by weight to 10 parts by weight of a moisturizer.

11. The moisture-sensed shrinking ink of claim 10, wherein the moisturizer is glycerol, diethylene glycol, propylene glycol methyl ether, or combinations thereof.

12. The moisture-sensed shrinking ink of claim 1, further comprising 0.002 parts by weight to 0.020 parts by weight of a defoamer.
